(19) United States
(12) Patent Application Publication
(10) Pub. No.: US 2026/0228099 A1
(43) Pub. Date: Aug. 6, 2026

(54) FAILURE DETECTION IN AN ELECTRONIC DEVICE BY MONITORING THERMAL RESISTANCE

(71) Applicant: NVIDIA CORPORATION, Santa Clara, CA (US)

(72) Inventors: Elad ALON, Bellevue (WA); Lior LIRAM, Tel-Aviv (IL); Beeri HALACHMI, Kohav Yair (IL)

(21) Appl. No.: 19/047,458

(22) Filed: Feb. 6, 2025

(51) Int. Cl. G06F 11/30

(52) U.S. Cl. CPC G06F 11/3055; G06F 11/3062

(57) ABSTRACT

According to various embodiments, a method for monitoring an electronic device includes: determining, based at least on thermal telemetry data associated with the electronic device, a thermal resistance between a cooling medium and a heat-generating component of the electronic device; and based at least on the thermal resistance, determining an operational status of the electronic device.

### BACKGROUND

### Field of the Various Embodiments

The various embodiments relate generally to computer systems and thermal solution technology, and, more specifically, to failure detection in an electronic device by monitoring thermal resistance.

### DESCRIPTION OF THE RELATED ART

Many Internet services, such as video steaming, cloud computing, cloud storage, and the like, are enabled by data centers. A data center is a physical facility that houses a network of computing and data storage resources in a central location, such as central processing unit (CPU) based servers, graphics processing unit (GPU) based servers, network routers, network switches, storage systems, network-interface controllers (NICs), and the like. The aforementioned electronic devices are heat-sensitive despite the fact that they generate significant heat during operation. Consequently, to ensure that such electronic devices do not exceed safe operating temperatures, data centers closely monitor temperature metrics and actively cool the electronic devices with a cooling medium, such as air or water. For example, a fan speed of an electronic device can be increased to force more cooling air across the electronic device or a greater volume of cooling water can be directed to a heat sink of the electronic device.

One drawback of conventional cooling systems for electronic devices in data centers is that such systems can mask warning signs indicating that a particular electronic device is nearing failure. For example, as a heat sink of a GPU or a thermal interface material coupling the heat sink to the GPU fails, the ability of the heat sink to cool the GPU declines. However, by increasing the volume of cooling air flowing over the heat sink, and/or by throttling the maximum clock speed of the GPU, the GPU can continue to operate below a maximum operating temperature. Consequently, a failure of the GPU may not be detectable until the GPU is no longer capable of operating below the maximum operating temperature and shuts down, oftentimes without any warning. As a result, all jobs executing on the GPU are terminated, which can cause undesirable outcomes relative to the operation of data center applications. In addition, prior to the thermally induced shutdown of the GPU, throttling the maximum clock speed of the GPU can cause significant performance degradation due to the computational speed of the GPU being reduced. Further, as the ability of the heat sink to cool the GPU declines over time, more power is required by the cooling system to remove a given quantity of heat from the GPU. As a result, more power is consumed to increase the flow of cooling air or water to the degraded heat sink to compensate for the reduced thermal performance of the heat sink.

As the foregoing illustrates, what is needed in the art are more effective techniques for detecting failures in electronic devices that are cooled during operation.

### SUMMARY

According to various embodiments, a method for monitoring an electronic device includes: determining, based at least on thermal telemetry data associated with the electronic device, a thermal resistance between a cooling medium and a heat-generating component of the electronic device; and based at least on the thermal resistance, determining an operational status of the electronic device.

At least one technical advantage of the disclosed techniques relative to the prior art is that the disclosed techniques enable early detection of a failure in thermal performance of an electronic device, thereby facilitating a preemptive replacement of the electronic device, cooling components associated with the electronic device, etc., as well as preventing an unexpected thermally induced shutdown of the electronic device. Another technical advantage is that the disclosed techniques can prevent performance degradation caused by thermal throttling of the electronic device, as well as excessive consumption of cooling power of the electronic device when the electronic device and/or cooling components associated with the electronic device are experiencing poor or deteriorating thermal performance. In particular, the disclosed techniques can detect the poor or deteriorating thermal performance and indicate that the electronic device, cooling components associated with the electronic device, etc., should be replaced. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a computer system configured to implement one or more aspects of the various embodiments.

FIG. 2 is a conceptual illustration of a portion of a data center, according to various embodiments.

FIG. 3 is a flow diagram of method steps for monitoring the thermal performance of an electronic device included in the data center of FIG. 2, according to various embodiments.

FIG. 4 is a conceptual illustration of a layer model that approximates the thermal behavior of the electronic device of FIG. 2, according to various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### INTRODUCTION

According to various embodiments, thermally related hardware telemetries for an electronic device in a data center are utilized to determine a metric of the thermal performance of the electronic device. Changes in the value of the metric for a particular electronic device can indicate that a thermal characteristic of the electronic device has changed and therefore the electronic device is in the initial stages of thermal failure. For example, in some embodiments, a value for a thermal resistance θ between a heat-generating component of the electronic device and a cooling medium is determined based on certain thermal telemetry data. In other embodiments a value for a thermal capacity C of the heat-generating component is also determined. The current value for thermal resistance θ and/or thermal capacity C is compared to previously determined values and/or to threshold values for thermal resistance θ and/or thermal capacity C to determine an operational status of the electronic device. For example, in some embodiments, when the current value for thermal resistance θ increases above a threshold value, the operational status of the electronic device is determined to be no longer fully operational, indicating replacement to avoid an unplanned thermally induced shutdown of the electronic device.

The approach employed to determine thermal resistance θ and/or thermal capacity C can vary depending on how frequently the thermal telemetry data is collected. In some embodiments, a current value for thermal resistance θ and a current value for thermal capacity C are determined via a transient analysis of thermally related telemetry data, in which high-frequency samples of the telemetry data are used to numerically solve a set of differential equations. In other embodiments, for example when there is no access to high-frequency telemetry data, a current value for thermal resistance θ is determined while the electronic device is in a steady state condition. In such embodiments, the current value for thermal resistance θ can be determined by dividing the difference in temperature between the heat-generating component of the electronic device and the cooling medium by the rate of energy consumption (power) of the heat-generating component.

### System Overview

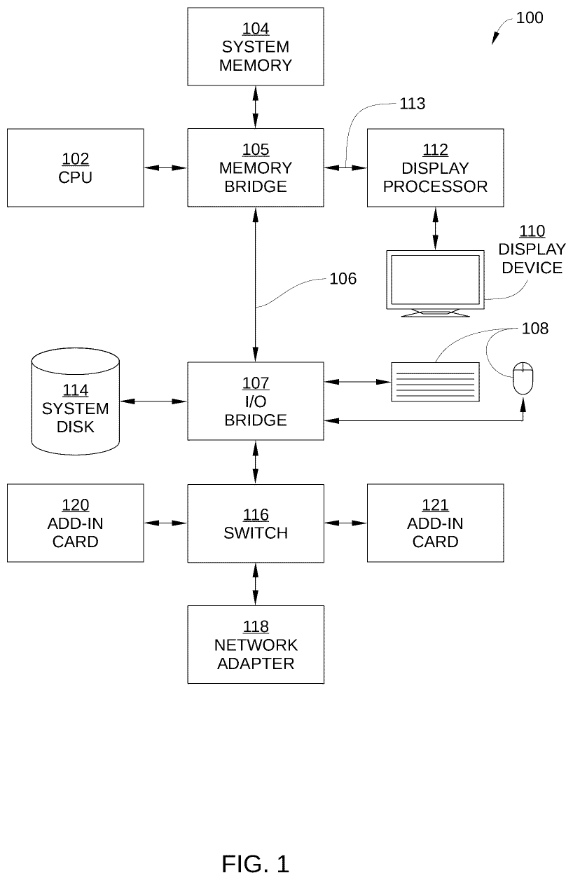

FIG. 1 is a conceptual illustration of a system 100 configured to implement one or more aspects of the various embodiments. As shown, system 100 includes a central processing unit (CPU) 102 and a system memory 104 communicating via a bus path that may include a memory bridge 105. CPU 102 includes one or more processing cores, and, in operation, CPU 102 is the master processor of system 100, controlling and coordinating operations of other system components. System memory 104 stores software applications and data for use by CPU 102. CPU 102 runs software applications and optionally an operating system. Memory bridge 105, which may be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment, display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 112 periodically delivers pixels to a display device 110 (e.g., a screen or conventional CRT, plasma, OLED, SED or LCD based monitor or television). Additionally, display processor 112 may output pixels to film recorders adapted to reproduce computer generated images on photographic film. Display processor 112 can provide display device 110 with an analog or digital signal. In various embodiments, a graphical user interface is displayed to one or more users via display device 110, and the one or more users can input data into and receive visual output from the graphical user interface.

A system disk 114 is also connected to I/O bridge 107 and may be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 116 provides connections between I/O bridge 107 and other components such as a network adapter 118 and various add-in cards 120 and 121. Network adapter 118 allows system 100 to communicate with other systems via an electronic communications network, and may include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 is configured as a processing subsystem that incorporates circuitry optimized for graphics and video processing, including, for example, video output circuitry, and constitutes a graphics processing unit (GPU). In another embodiment, display processor 112 is configured as a processing subsystem that incorporates circuitry optimized for general purpose processing. In yet another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments, instructions and/or data representing a scene are provided to a render farm or a set of server computers, each similar to system 100, via network adapter 118 or system disk 114. The render farm generates one or more rendered images of the scene using the provided instructions and/or data. These rendered images may be stored on computer-readable media in a digital format and optionally returned to system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In an embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

Further, in other embodiments, CPU 102 or display processor 112 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 102, display processor 112, or one or more other processing devices or any combination of these different processors.

CPU 102, render farm, and/or display processor 112 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 100 may or may not include other elements shown in FIG. 1. System memory 104 and/or other memory units or devices in system 100 may include instructions that, when executed, cause a robot or robotic device represented by system 100 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies, display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

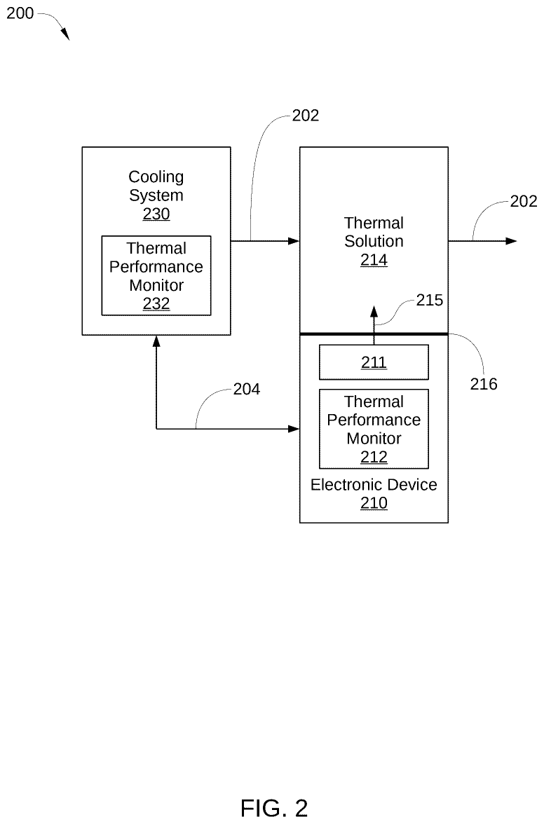

FIG. 2 is a conceptual illustration of a portion 200 of a data center, according to various embodiments. As shown, portion 200 of the data center includes an electronic device 210 and an associated cooling system 230 that forces a cooling medium 202 through a thermal solution 214 of electronic device 210. In some embodiments, electronic device 210 can be implemented as system 100, CPU 102, display processor 112, and/or one of add-in cards 120, 121 in FIG. 1.

In the embodiment illustrated in FIG. 2, portion 200 includes a single electronic device 210 and a single cooling system 230. In other embodiments, portion 200 includes a plurality of electronic devices 210 and/or a plurality of cooling systems 230. In yet other embodiments, portion 200 includes a single cooling system 230 that serves a plurality of electronic devices 210. In some embodiments, a data center can include many instances of portion 200, for example on the order of hundreds or thousands.

Electronic device 210 can be any computing, networking, or data storage device residing in a data center that is actively cooled during operation. In general, electronic device 210 includes one or more heat-generating components 211 that generate heat during operation, such as one or more processors, processor cores, other integrated circuits, optical modules, lasers, and/or the like. Because some or all of heat-generating components 211 are typically also temperature-sensitive components, during operation, thermal energy 215 is removed from electronic device 210, for example via thermal solution 214. In this way, electronic device 210 and the one or more heat-generating components 211 do not exceed safe operating temperatures. Examples of electronic device 210 include, without limitation, a CPU-based server, a GPU-based server, a network router, a network switch, a storage system, a network-interface controller (NIC), and the like. Examples of a heat-generating component 211 include a CPU, a GPU, a network on chip (NoC), a system on chip (SoC), a laser diode, a random-access memory (RAM) module, a flash memory chip, and the like.

Thermal solution 214 can be any suitable device that can be coupled to and/or included in electronic device 210 and transfers thermal energy 215 generated by heat-generating component 211 to a cooling medium 202, such as air, water, or other cooling fluid. In some embodiments, thermal solution 214 is coupled directly to heat-generating component 211, for example via a thermal interface material (TIM) 216. Thermal solution 214 facilitates the transfer of thermal energy 215 to cooling medium 202, thereby enabling heat-generating component 211 to produce more thermal energy 215 without overheating electronic device 210.

In some embodiments, thermal solution 214 includes a heat sink with fins. In such embodiments, a fan included in cooling system 230 forces air across the fins of the heat sink. Alternatively, or additionally, in some embodiments, thermal solution 214 includes a vapor chamber, one or more heat pipes, or any other multi-phase heat-transfer devices that employ phase transition to transfer heat away from heat-generating component 211. In other embodiments, thermal solution 214 includes a liquid cold plate. In such embodiments, a pump included in cooling system 230 forces a cooling fluid, such as water, across the cold plate to remove thermal energy 215 from thermal solution 214.

Cooling system 230 can be any conventional system that operates to prevent electronic device 210 and/or heat-generating component 211 from exceeding a threshold acceptable temperature during operation. Cooling system 230 can include an air-based cooling system and/or a liquid-based cooling system. As shown, cooling system 230 receives thermal telemetry data 204 from electronic device 210 and causes cooling medium 202 to flow through and/or across thermal solution 214.

Generally, thermal telemetry data 204 includes information typically collected for the normal operation of electronic device 210, such as a value for a temperature of heat-generating component 211 and/or a value for a power consumed by heat-generating component 211. In some embodiments, the value for the temperature can be a single measured value. Alternatively, in some embodiments, the value for the temperature can be based on multiple measured values, such as an average of multiple measurement locations within heat-generating component 211. Similarly, in some embodiments, the value for the power consumed by heat-generating component 211 can be a single measured value. Alternatively, in some embodiments, the value for the power consumed can be based on multiple measured values, such as an average of multiple components of heat-generating component 211 (e.g., different computing cores).

In some embodiments, thermal telemetry data 204 includes information associated with cooling system 230, such as a value for a fan speed of cooling system 230, a value for a temperature of cooling medium 202, and/or a value for an indicator of a liquid coolant flow rate. Examples of an indicator of liquid coolant flow rate include a liquid coolant pressure, a liquid coolant velocity, and a liquid coolant pump speed. Typically, the temperature of the cooling medium 202 is measured in electronic device 210 prior to being heated by thermal solution 214, for example at a fan inlet or at a location in a liquid supply pipe that is upstream of thermal solution 214.

When cooling system 230 is air-based, cooling medium 202 is air that is forced through or across thermal solution 214 via a fan included in cooling system 230. In such embodiments, cooling system 320 may control the flow rate of cooling medium 202 to the thermal solution 214 of a particular electronic device 210 based on thermal telemetry data 204 associated with that particular electronic device 210. For example, in some embodiments, as an operating temperature of electronic device 210 and/or heat-generating component 211 approaches a threshold operating temperature, cooling system 230 increases a fan speed to increase the flow of air across thermal solution 214.

When cooling system 230 is liquid-based, cooling medium 202 is a cooling liquid such as water, ethylene glycol, and the like, and is transported to and from thermal solution 214 via pipes or other conduits. In such embodiments, cooling system 320 may control the flow rate of cooling medium 202 to the thermal solution 214 of a particular electronic device 210 based on thermal telemetry data 204 associated with that particular electronic device 210. Thus, in some embodiments, as an operating temperature of electronic device 210 and/or heat-generating component 211 approaches a threshold operating temperature, cooling system 230 increases a flow rate of the cooling fluid to thermal solution 214, for example by increasing a pump speed and/or opening a control valve associated with that particular electronic device 210.

In some embodiments, cooling system 230 is internal to electronic device 210, for example when cooling system 230 is an air-based system with one or more fans dedicated to forcing cooling air through cooling fins of thermal solution 214. In such embodiments, a controller (not shown) for cooling system 230 can reside within electronic device 210 and control the fan speed of the one or more cooling fans based on thermal telemetry data 204. In other embodiments, cooling system 230 can be implemented as a centralized cooling system that is external to electronic device 210, for example when cooling system 230 is a liquid-based system that serves a plurality of electronic devices 210. In such embodiments, a controller (not shown) for cooling system 230 can be implemented external to electronic device 210 and control a pump speed and/or a flow control valve based on thermal telemetry data 204. In such embodiments, the controller may control the flow of cooling medium 202 for each of a plurality of electronic devices 210 to regulate the temperature of each electronic device 210.

According to various embodiments, portion 200 of a data center includes a thermal performance monitor that can determine a metric of the thermal performance of electronic device 210 based on thermal telemetry data 204, where the metric quantifies one or more thermal characteristics of electronic device 210 and the associated thermal solution 214. In some embodiments, the thermal performance monitor is deployed as firmware and/or hardware that resides within electronic device 210, for example as thermal performance monitor 212. In other embodiments, the thermal performance monitor is deployed as firmware and/or hardware that resides within cooling system 230, for example as thermal performance monitor 232. In either case, the thermal performance monitor is configured to implement various embodiments as described herein.

### Failure Detection by Monitoring Thermal Resistance

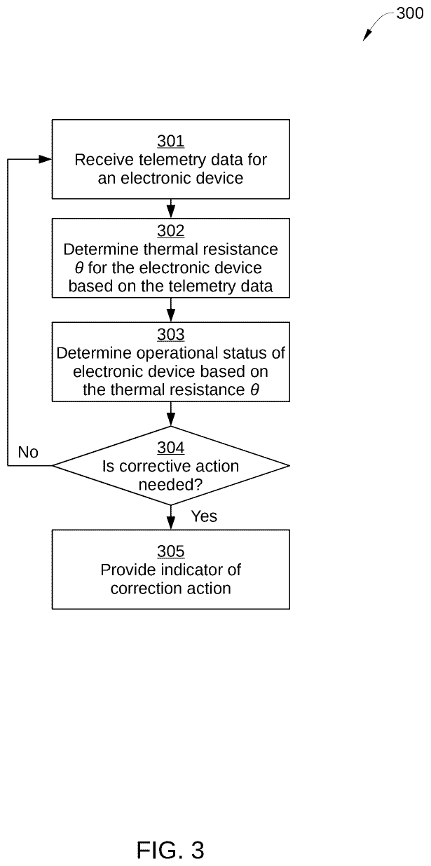

FIG. 3 is a flow diagram of method steps for monitoring the thermal performance of an electronic device included in a data center, according to various embodiments. Although the method steps are shown in an order, persons skilled in the art will understand that some method steps may be performed in a different order, repeated, omitted, and/or performed by components other than those described in FIG. 3. Although the method steps are described with respect to the system of FIG. 2, persons skilled in the art will understand that any system configured to perform the method steps, in any order, falls within the scope of the various embodiments.

As shown, a method 300 begins at step 301, where a thermal performance monitor (e.g., thermal performance monitor 212 or thermal performance monitor 232) receives thermal telemetry data 204 for electronic device 210. As noted previously, thermal telemetry data 204 can include one or more values for a temperature of heat-generating component 211, a power consumed by heat-generating component 211, a fan speed of cooling system 230, a temperature of cooling medium 202, and/or an indicator of a liquid coolant flow rate, among others.

At step 302, the thermal performance monitor determines thermal resistance θ based on thermal telemetry data 204 received in step 301. In step 302, the approach employed to determine thermal resistance θ and/or thermal capacity C can vary depending on how frequently the thermal telemetry data is collected. It is noted that a value of thermal resistance θ determined in step 302 is not a directly measured value, and instead is an estimated or calculated value for thermal resistance θ. Thus, in some embodiments, the value of thermal resistance θ is a metric that is correlated with the actual thermal resistance θ of heat-generating component 211. It is further noted that, under certain conditions and/or for certain configurations of heat-generating component 211, there can be a constant unknown bias included in one or more values of thermal telemetry data 204. For example, in some situations, such a constant unknown bias can arise from bad sensor calibration, telemetry issues, and/or inherent architectural limitations of heat-generating component 211 and/or electronic device 210. It will be appreciated that in such instances, the term “thermal resistance,” as employed herein, can apply to a value that is not exactly equivalent to thermal resistance, but can still correspond to a value that indicates a thermal characteristic of heat-generating component 211 and/or electronic device 210 has changed.

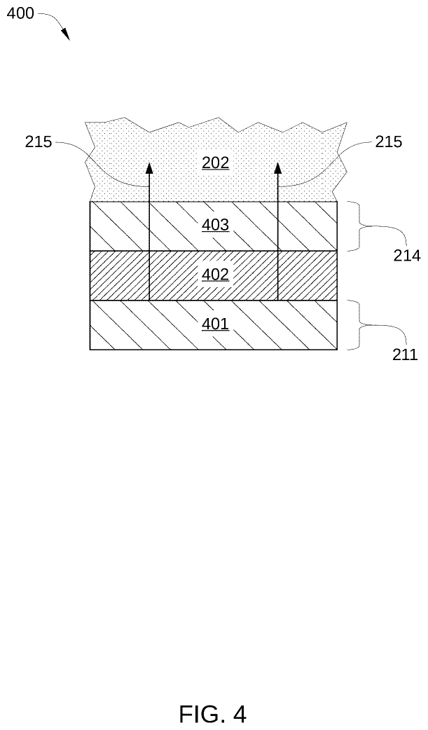

In some embodiments, when there is no access to high-frequency telemetry data, a current value for thermal resistance θ is determined while the electronic device is in a steady state condition. While some heat-generating components 211 (e.g., GPUs and CPUs) may include multiple sensors that measure temperature at a high-frequency, other heat-generating components 211 frequently include sensors that sample temperature a relatively low sampling rates. For example, network switches can have a sampling rate on the order of one measurement per minute, which is orders of magnitude greater than the time constant of thermal conduction T for the heat-generating components 211 included in a network switch, such as high-power integrated circuits. In such embodiments, the current value for thermal resistance θ can be determined based on Equation 1:

$$( {T}_{Component} - {T}_{Ambient} ) / P = {θ}_{Effective} \qquad ( 1 )$$

wherein T_{Component} is the measured temperature of heat-generating component 211, T_{Ambient} is the measured temperature of cooling medium 202, P is the power consumption of heat-generating component 211, θ_{Effective} is the effective thermal resistance between heat-generating component 211 and cooling medium 202. In Equation 1, θ_{Effective} is the sum of the thermal resistances for each layer of electronic device 210 when the thermal behavior of electronic device 210 is assumed to follow a simplified layer model. One example embodiment of such a layer model is described below in conjunction with FIG. 4.

FIG. 4 is a conceptual illustration of a layer model 400 that approximates the thermal behavior of electronic device 210, according to various embodiments. Layer model 400 includes multiple layers that thermally have zero thickness, but are shown with finite thickness in FIG. 4 for clarity. In the embodiment illustrated in FIG. 4, layer model 400 includes a silicon layer 401 that represents heat-generating component 211, a portion 403 of thermal solution 214, and a TIM layer 402 that represents a TIM thermally coupling heat-generating component 211 to portion 403. Portion 403 corresponds to a portion of thermal solution 214 that is proximate to heat-generating component 211 and is disposed between heat-generating component 211 and cooling medium 202. In other embodiments, layer model 400 can include additional layers as appropriate. For example, in embodiments in which heat-generating component 211 corresponds to a GPU with a lidded package, layer model 400 may include an additional zero-thickness layer representing the lid of the lidded package, which is disposed between silicon layer 401 and portion 403.

In some embodiments, layer model 400 is a zero-dimensional model. Thus, in layer model 400, silicon layer 401, TIM layer 402, and portion 403 of thermal solution 214 behave in accordance with a lumped-capacitance model, which is a common approximation in transient conduction that assumes that heat conduction within each layer of layer model 400 is much faster than heat transfer across the boundary of each layer of layer model 400. Layer model 400 further assumes that each layer has a specific thermal capacity C that is constant with temperature and that there is a uniform temperature within each layer. As a result, when power consumed by heat-generating component 211 is converted to heat in silicon layer 401, thermal energy 215 flows between adjacent layers and between portion 403 and cooling medium 202. Based on the above-described assumptions, in a steady-state thermal condition, thermal resistance between cooling medium 202 and portion 403 depends on fan speed, and corresponds to θ_{Effective} in Equation 1. Thus, θ_{Effective} is the sum of the thermal resistances between each layer of electronic device 210 represented in layer model 400.

Returning to FIG. 3, in step 302, effective thermal resistance @Effective can be determined using Equation 1 when electronic device 210 and heat-generating component 211 are in a state of thermal equilibrium, and therefore are thermally in a steady state. In some embodiments, the thermal performance monitor can determine that electronic device 210 and heat-generating component 211 are thermally in a steady state based on one or more conditions. For example, in some embodiments, the thermal performance monitor determines that electronic device 210 and heat-generating component 211 are thermally in a steady state when a time interval is detected during which a temperature of heat-generating component 211 remains constant within a specified temperature difference, such as ±1° C. Additionally, or alternatively, in some embodiments, the thermal performance monitor determines that electronic device 210 and heat-generating component 211 are thermally in a steady state when a time interval is detected during which power consumed by heat-generating component 211 remains constant within a specified power difference, such as ±2 W. Additionally, or alternatively, in embodiments in which heat-generating component 211 is a network switch or network router, the thermal performance monitor determines that electronic device 210 and heat-generating component 211 are thermally in a steady state when a time interval is detected during which receipt and/or transmission of data does not change by more than a threshold level, such as ±150 KB/s. In some embodiments, the thermal performance monitor checks for the steady state during a sliding window, for example five minutes. Additionally, or alternatively, in some embodiments, the thermal performance monitor checks for the steady state periodically and/or at specified times.

In some embodiments, the thermal performance monitor can determine that electronic device 210 and heat-generating component 211 are thermally in a steady state based on one or more conditions that can depend on specific characteristics of heat-generating component 211. For example, in an embodiment in which heat-generating component 211 is implemented as a network switch that provides low-frequency monitoring of temperature, the thermal performance monitor can confirm that the electronic device 210 and heat-generating component 211 are thermally in a steady state based on an output from a cumulative counter that is included in thermal telemetry data 204. In such embodiments, the cumulative counter reports a number of packets sent and received by the network switch during the time interval between temperature measurements. Thus, in such embodiments, the thermal performance monitor does not consider heat generating component 211 to be in a steady-state condition during a time interval in which the cumulative counter exceeds a threshold value.

In some embodiments, the minimum duration of a time interval during which the thermal performance monitor detects a steady-state condition is greater than the time constant of thermal conduction T for heat-generating component 211. Generally, the time constant of thermal conduction T is a characteristic time constant that can be determined based on layer model 400. In some embodiments, to ensure that heat-generating component 211 has actually reached a steady-state condition, the minimum duration of a time interval during which the thermal performance monitor detects a steady-state condition is four to five times greater than the time constant of thermal conduction T for heat-generating component 211.

In some embodiments, a current value for thermal resistance θ and a current value for thermal capacity C are determined via a transient analysis of thermal telemetry data 204. In such embodiments, high-frequency samples of thermal telemetry data 204 are used to numerically solve a set of differential equations, where the differential equations are based on a layer model of heat-generating component 211, such as layer model 400 in FIG. 4. In such embodiments, the time interval associated with each sampling thermal telemetry data 204 is significantly less than the time constant of thermal conduction T for heat-generating component 211, for example an order of magnitude less. Generally, such high-frequency sampling is available for GPUs, CPUs, and/or other high-power integrated circuits.

In some embodiments, based on a layer model of heat-generating component 211 that includes N layers, a system of N differential equations can be developed for a particular configuration of heat-generating component 211. For example, for a particular model of a GPU, a specific system of N differential equations is developed. Then, for that particular configuration of heat-generating component 211, the thermal model is completed by performing a series of physical measurements on an instance of that particular configuration of heat-generating component 211, where the measurements quantify the thermal behavior of that particular configuration of heat-generating component 211 under various conditions. A thermal model based on such measurements can then enable the determination of the thermal resistance θ between each of the N layers of heat-generating component 211.

In some embodiments, the measurements include a temperature measurement of heat-generating component 211 when a power consumption of heat-generating component 211 is changed from a first value to a second value and a fan speed remains constant. Such temperature measurements are typically repeated for a range of different fan speeds and power consumption changes. In some embodiments, the measurements include a temperature measurement of heat-generating component 211 when a power consumption of heat-generating component 211 is changed repeatedly between a first value to a second value in a rectangular wave pattern while a fan speed remains constant. Such temperature measurements are typically repeated for multiple different fan speeds. In some embodiments, the measurements include a temperature measurement of heat-generating component 211 when a power consumption of heat-generating component 211 is changed through a series of ascending and/or descending “staircases” of changing values while a fan speed remains constant. Such temperature measurements are typically repeated for a range of different fan speeds.

Given the above-described thermal model for a particular configuration of heat-generating component 211 and high-frequency thermal telemetry data 204, the thermal resistance θ between each of the N layers for a particular instance of electronic device 210 and the thermal capacity C of each of the N layers of electronic device 210 can be determined in real time based on thermal telemetry data 204. Specifically, a model fit can be performed on the thermal telemetry data 204 received in step 301 (e.g., GPU temperature and GPU power consumption) to generate the thermal resistance θ between each of the N layers of electronic device 210 and the thermal capacity C of each of the N layers of electronic device 210.

In some embodiments, in lieu of a thermal model, a transient analysis of thermal telemetry data 204 is performed via a suitably trained neural network or other machine-learning model. Thus, in such embodiments, the machine-learning model is applied to estimate the thermal resistance θ between each of the N layers and the thermal capacity C of each of the N layers based on certain training and thermal telemetry data 204. In some embodiments, the training can include one or more of the physical measurements described above for completing a thermal model. Alternatively, or additionally, in some embodiments, the training can include physical measurements of one or more heat-generating devices 210 for which the thermal resistance θ and/or the thermal capacity C is known.

In some embodiments, the model fit procedure of step 302 can be performed when a temperature of cooling medium 202 is not known. For example, in some embodiments, a temperature of cooling medium 202 can be an additional output of a model fit procedure when the temperature of cooling medium 202 is included as one of the physical measurements performed when completing the thermal model. Thus, in some embodiments, step 302 can be performed when thermal telemetry data 204 does not include a temperature of cooling medium 202.

In step 303, the thermal performance monitor determines the operational status of electronic device 210 based on the thermal resistance θ. For example, in some embodiments, the thermal performance monitor determines the operational status of electronic device 210 is either operational, partially operational (e.g., in need of inspection and/or replacement), or non-operational (e.g., in need of immediate replacement).

In some embodiments, the thermal performance monitor compares the thermal resistance θ determined in step 302 to a thermal resistance associated with a population of similar electronic devices. In such embodiments, when the thermal resistance θ of heat-generating component 211 begins to increase relative to the thermal resistance associated with similar electronic devices, thermal performance monitor can indicate that heat-generating component 211 and/or electronic device 210 is undergoing thermal failure or is susceptible to thermal failure, and therefore is either partially operational or non-operational. In another example, in some embodiments, the thermal performance monitor compares the thermal resistance θ determined in step 302 to a previously measured thermal resistance θ determined for heat-generating component 211. In such embodiments, the thermal performance monitor can track the thermal behavior of heat-generating component 211 over time. Thus, when the measured thermal resistance θ of heat-generating component 211 increases over time, the thermal performance monitor can detect such a trend, even though heat-generating component 211 and electronic device 210 are currently operating within a safe temperature regime. Consequently, issues that affect the thermal performance of thermal solution 214 but do not immediately cause a thermally induced shutdown of electronic device 210 can be detected. Examples of such issues include a partially malfunctioning TIM 216, a cracked or poorly attached heat sink, a heat sink with contaminated cooling fins, the slow accumulation of biological contamination in a liquid cooling medium, a partial blockage of the conduits that provide a liquid cooling medium to thermal solution 214, and the like. In such embodiments, the thermal performance monitor can determine that electronic device 210 is therefore either partially operational or non-operational.

In step 304, the thermal performance monitor determines whether corrective action is needed for electronic device 210. For example, when electronic device 210 has an operational status of “operational,” no corrective action is needed, and when electronic device 210 has an operational status of “partially operational” or “non-operational,” certain corrective action is needed. When the thermal performance monitor determines that no corrective action is needed, method 300 returns to step 301; when the thermal performance monitor determines corrective action is needed, method 300 proceeds to step 305.

In step 305, the thermal performance monitor provides an indicator of the corrective action needed for electronic device 210. For example, in some instances, immediate replacement of electronic device 210 can be indicated. In other instances, inspection and/or scheduled replacement of electronic device 210 can be indicated. The indicator can include one or more of an audible alarm, a visual alarm, and/or a message transmitted to a central controller of the data center.

In sum, the various embodiments shown and provided herein set forth techniques for monitoring the thermal performance of an electronic device. In some embodiments, a value for a thermal resistance θ between a heat-generating component of the electronic device and a cooling medium is determined based on certain thermal telemetry data. The current value for thermal resistance θ is compared to previously determined values, and/or to threshold values, for thermal resistance θ to determine an operational status of the electronic device.

At least one technical advantage of the disclosed techniques relative to the prior art is that the disclosed techniques enable early detection of a failure in thermal performance of an electronic device, thereby facilitating a preemptive replacement of the electronic device, cooling components associated with the electronic device, etc., as well as preventing an unexpected thermally induced shutdown of the electronic device. Another technical advantage is that the disclosed techniques can prevent performance degradation caused by thermal throttling of the electronic device, as well as excessive consumption of cooling power of the electronic device when the electronic device and/or cooling components associated with the electronic device are experiencing poor or deteriorating thermal performance. In particular, the disclosed techniques can detect the poor or deteriorating thermal performance and indicate that the electronic device, cooling components associated with the electronic device, etc., should be replaced. These technical advantages provide one or more technological advancements over prior art approaches.
1. In some embodiments, a method for monitoring an electronic device includes: determining, based at least on thermal telemetry data associated with the electronic device, a thermal resistance between a cooling medium and a heat-generating component of the electronic device; and based at least on the thermal resistance, determining an operational status of the electronic device.
2. The method of clause 1, wherein determining the operational status of the electronic device comprises comparing the thermal resistance between the cooling medium and the heat-generating component of the electronic device to a thermal resistance associated with a plurality of electronic devices.
3. The method of clauses 1 or 2, wherein determining the operational status of the electronic device comprises comparing the thermal resistance of the electronic device to a previously measured thermal resistance between the cooling medium and the heat-generating component.
4. The method of any of clauses 1-3, further comprising generating an indicator corresponding to the operational status of the electronic device.
5. The method of any of clauses 1-4, wherein determining the thermal resistance between the cooling medium and the heat-generating component of the electronic device comprises determining the heat-generating component is in a state of thermal equilibrium.
6. The method of any of clauses 1-5, wherein the thermal resistance between the cooling medium and the heat-generating component of the electronic device is determined based on at least one of: a power consumption of the heat-generating component, a temperature of the cooling medium, or a fan speed.
7. The method of any of clauses 1-6, wherein the thermal resistance between the cooling medium and the heat-generating component of the electronic device is determined based on at least one of: a power consumption of the heat-consuming device, a temperature of the cooling medium, or an indicator of a cooling liquid flow rate.
8. The method of any of clauses 1-7, wherein determining that the heat-generating component is in the state of thermal equilibrium comprises monitoring at least one of a power consumption of the heat-consuming device or a temperature of the heat-consuming device.
9. The method of any of clauses 1-8, wherein the thermal telemetry data associated with the electronic device comprises a first plurality of values for a temperature of the heat-generating component and a second plurality of values for power consumed by the heat-generating component.
10. The method of any of clauses 1-9, wherein determining the thermal resistance between the cooling medium and the heat-generating component of the electronic device comprises performing a model fit on the first plurality of values for the temperature of the heat-generating component and the second plurality of values for the power consumed by the heat-generating component.
11. The method of any of clauses 1-10, wherein the thermal telemetry data does not include a value of the cooling medium.
12. The method of any of clauses 1-11, wherein receipt of each value for the temperature of the heat-generating component is separated by a time interval that is less than a time constant associated with the heat-generating component.
13. The method of any of clauses 1-12, wherein the thermal telemetry data includes one or more of: a value for a temperature of the heat-generating component of the electronic device, a value for a power consumed by the heat-generating component of the electronic device, a value for a fan speed of a cooling system associated with the electronic device, a value for a temperature of the cooling medium, or a value for an indicator of a liquid coolant flow rate.
14. The method of any of clauses 1-13, wherein the electronic device comprises a graphics processing unit, a central processing unit, a network-interface controller, a network switch, a network router, an optical module, or a laser.
15. In some embodiments, an electronic device includes: a heat-generating component that is cooled by a cooling medium; and a controller that: receives thermal telemetry data associated with the electronic device; based on the thermal telemetry data, determines a thermal resistance between the cooling medium and the heat-generating component of the electronic device; and based on the thermal resistance, determines an operational status of the electronic device.
16. The electronic device of clause 15, wherein the controller determines the operational status of the electronic device by comparing the thermal resistance between the cooling medium and the heat-generating component of the electronic device to a thermal resistance associated with a plurality of electronic devices.
17. The electronic device of clauses 15 or 16, wherein the controller determines the operational status of the electronic device by comparing the thermal resistance of the electronic device to a previously measured thermal resistance between the cooling medium and the heat-generating component.
18. The electronic device of any of clauses 15-17, wherein determining the thermal resistance between the cooling medium and the heat-generating component of the electronic device comprises applying one or more machine-learning models.
19. The electronic device of any of clauses 15-18, wherein determining the thermal resistance between the cooling medium and the heat-generating component of the electronic device comprises determining the heat-generating component is in a state of thermal equilibrium.
20. The electronic device of any of clauses 15-19, wherein receiving the thermal telemetry data associated with the electronic device comprises receiving a first plurality of values for a temperature of the heat-generating component and a second plurality of values for a power consumed by the heat-generating component.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors or gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method for monitoring an electronic device, the method comprising:
determining, based at least on thermal telemetry data associated with the electronic device, a thermal resistance between a cooling medium and a heat-generating component of the electronic device; and
based at least on the thermal resistance, determining an operational status of the electronic device.

2. The method of claim 1, wherein determining the operational status of the electronic device comprises comparing the thermal resistance between the cooling medium and the heat-generating component of the electronic device to a thermal resistance associated with a plurality of electronic devices.

3. The method of claim 1, wherein determining the operational status of the electronic device comprises comparing the thermal resistance of the electronic device to a previously measured thermal resistance between the cooling medium and the heat-generating component.

4. The method of claim 1, further comprising generating an indicator corresponding to the operational status of the electronic device.

5. The method of claim 1, wherein determining the thermal resistance between the cooling medium and the heat-generating component of the electronic device comprises determining the heat-generating component is in a state of thermal equilibrium.

6. The method of claim 5, wherein the thermal resistance between the cooling medium and the heat-generating component of the electronic device is determined based on at least one of: a power consumption of the heat-generating component, a temperature of the cooling medium, or a fan speed.

7. The method of claim 5, wherein the thermal resistance between the cooling medium and the heat-generating component of the electronic device is determined based on at least one of: a power consumption of the heat-consuming device, a temperature of the cooling medium, or an indicator of a cooling liquid flow rate.

8. The method of claim 5, wherein determining that the heat-generating component is in the state of thermal equilibrium comprises monitoring at least one of a power consumption of the heat-consuming device or a temperature of the heat-consuming device.

9. The method of claim 1, wherein the thermal telemetry data associated with the electronic device comprises a first plurality of values for a temperature of the heat-generating component and a second plurality of values for power consumed by the heat-generating component.

10. The method of claim 9, wherein determining the thermal resistance between the cooling medium and the heat-generating component of the electronic device comprises performing a model fit on the first plurality of values for the temperature of the heat-generating component and the second plurality of values for the power consumed by the heat-generating component.

11. The method of claim 9, wherein the thermal telemetry data does not include a value of the cooling medium.

12. The method of claim 9, wherein receipt of each value for the temperature of the heat-generating component is separated by a time interval that is less than a time constant associated with the heat-generating component.

13. The method of claim 1, wherein the thermal telemetry data includes one or more of: a value for a temperature of the heat-generating component of the electronic device, a value for a power consumed by the heat-generating component of the electronic device, a value for a fan speed of a cooling system associated with the electronic device, a value for a temperature of the cooling medium, or a value for an indicator of a liquid coolant flow rate.

14. The method of claim 1, wherein the electronic device comprises a graphics processing unit, a central processing unit, a network-interface controller, a network switch, a network router, an optical module, or a laser.

15. An electronic device, comprising:
a heat-generating component that is cooled by a cooling medium; and
a controller that:
receives thermal telemetry data associated with the electronic device;
based on the thermal telemetry data, determines a thermal resistance between the cooling medium and the heat-generating component of the electronic device; and
based on the thermal resistance, determines an operational status of the electronic device.

16. The electronic device of claim 15, wherein the controller determines the operational status of the electronic device by comparing the thermal resistance between the cooling medium and the heat-generating component of the electronic device to a thermal resistance associated with a plurality of electronic devices.

17. The electronic device of claim 15, wherein the controller determines the operational status of the electronic device by comparing the thermal resistance of the electronic device to a previously measured thermal resistance between the cooling medium and the heat-generating component.

18. The electronic device of claim 15, wherein determining the thermal resistance between the cooling medium and the heat-generating component of the electronic device comprises applying one or more machine-learning models.

19. The electronic device of claim 15, wherein determining the thermal resistance between the cooling medium and the heat-generating component of the electronic device comprises determining the heat-generating component is in a state of thermal equilibrium.

20. The electronic device of claim 15, wherein receiving the thermal telemetry data associated with the electronic device comprises receiving a first plurality of values for a temperature of the heat-generating component and a second plurality of values for a power consumed by the heat-generating component.
